(19) United States
(12) Patent Application Publication
(10) Pub. No.: US 2025/0266006 A1
(43) Pub. Date: Aug. 21, 2025

(54) NON-INTRUSIVE AMBIENT LIGHT SENSOR FOR FRONTLIGHT CONTROL

(71) Applicant: reMarkable A/S, Oslo (NO)

(72) Inventors: Terje Lassen, Oslo (NO); Patrick Brataas, Oslo (NO); Eirik Storesund, Oslo (NO); Hessel J.H. Vink, Oslo (NO); Andreas Eliassen, Oslo (NO)

(21) Appl. No.: 18/654,023

(22) Filed: May 3, 2024

Related U.S. Application Data
(60) Provisional application No. 63/464,227, filed on May 5, 2023.

(51) Int. Cl. G09G 3/34; G01J 1/42; G01J 1/44

(52) U.S. Cl. CPC G09G 3/342; G01J 1/4204; G01J 1/44; G09G 3/344; G09G 2360/144

(57) ABSTRACT

Embodiments of the invention provide a frontlight switch comprising an ambient light sensor system configured to detect ambient light levels received into a lightguide associated with the display on a tablet device. The ambient light sensor system may be configured to detect when ambient light levels are above or have fallen below a level where a user will be able to read the device screen and switch on or off the frontlight. The ambient light sensor may reside in the frontlight in the same layer as the LEDs associated with the frontlight, thus eliminating the need for separate light openings in the device.

### TECHNICAL FIELD

The disclosure relates generally to a frontlight, adapted for various display devices such as a digitizer or a tablet. In particular, embodiments of the present invention relate to an ambient light switch for engaging a frontlight in low lighting conditions.

### BACKGROUND

Mobile telephones, tablet computers, PCs, car entertainment systems, white goods and many other devices are commonly equipped with interactive displays. These interactive displays combine a display screen, such as an LCD, oLED, plasma or electrophoretic display (EPD), with an input system, such as a touch- or pen-stylus-input system. The input system recognizes the presence of an input object such as a pen-stylus touching or in close proximity to the display screen.

The displays screens, such as EPDs, included in these devices are typically passive in that they modulate light but do not produce light in the manner of other types of displays. As a consequence, when passive displays like EPD displays are placed in darkened environments, users may have difficulty seeing the display. In a completely darkened room, the user might not be able to see the display at all.

As a consequence, passive display devices may be equipped with various lighting means, such as a frontlight that adds light to the display enabling users to see the display in low ambient light conditions. FIG. 1 illustrates a prior art frontlight having a lightguide 103, a thin filament of a transparent material, such as glass or plastic, which is capable of transmitting light signals through successive internal reflections. The lightguide 103 receives its light from a plurality of light sources (e.g., LEDs 105a-105h) mounted on an LED circuit board 109 and then reflects the image from the underlying display (e.g., EPD not shown in FIG. 1 but located beneath the lightguide 103) so as to make the underlying image visible in low light levels. The light sources 105a-105h are located at various positions along the edge of the lightguide 103.

FIG. 2 illustrates a conventional prior art design in a passive display device 200 for an ambient light sensor 201 that automatically engages a frontlight (like the frontlight shown in FIG. 1) in an interactive display 202 when a low light level is detected. An input for the ambient light sensor 201 is conventionally located on the surface of the interactive display device 200 having the interactive display 202. Thus, a conventional solution for engaging the frontlight automatically calls for the ambient light sensor 201 to comprise a hole inserted somewhere on the surface of the display device 200 so that ambient light may pass through the hole where it is detected by an ambient light sensor portion of the ambient light sensor 201. Having detected the ambient light, the sensor 201 controls the level of frontlight employed and/or may turn off the frontlight when high levels of ambient light are detected to enable savings of battery power. The conventional input holes for ambient light sensors impact device design, and some users may find such holes unaesthetically pleasing. Moreover, such holes provide a possible entry point for dirt, dust, and/or water that could eventually impair or damage the ambient light sensor 201 and possibly the display device 200 as well. While great strides have been made in recent years in improving frontlights on passive display devices, further improvements are still warranted.

### SUMMARY OF THE INVENTION

Embodiments of the invention provide an ambient light sensor system that comprises a lightguide, an ambient light sensor that receives ambient light from the lightguide, a processor the receives an ambient light signal from the ambient light sensor, and a frontlight that can be controlled by the processor. When the processor determines that the received ambient light level detected by the ambient light sensor has fallen below a first threshold (e.g., the tablet display associated with the frontlight is too dim for users given the ambient light), then the processor turns the frontlight on. Conversely, when the processor determines that the ambient light level detected by the ambient light sensor has risen above a second threshold (e.g., ambient lighting conditions do not require the frontlight for reading the tablet display associated with the frontlight), then the processor turns the frontlight off.

In some embodiments of the invention, the ambient light sensor comprises an LED and the frontlight comprises a plurality of LEDs. The LED of the ambient light sensor may be positioned in the same layer as the LEDs of the frontlight. The LED employed for ambient light sensing sends an ambient light signal to the processor.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a prior art frontlight having a lightguide 103 that is directly coupled to an array of light sources (e.g., LEDs 105a-105h).

FIG. 2 illustrates a prior art ambient light sensor 201 in a display device 200.

FIG. 3 illustrates a system architecture for an e-paper tablet device 310 that receives inputs from the input mechanism such as a pen-stylus, according to one example embodiment.

FIG. 4 is a block diagram of the system architecture of an e-paper tablet device 310, according to one example embodiment.

FIG. 5 illustrates a front and right perspective view of an e-paper tablet 500 having the functionality described for the e-paper tablet device 310 in FIGS. 3-4.

FIG. 6 illustrates hardware components of an example Electrophoretic Display (EPD) operating in an e-paper tablet device 310, according to one example embodiment.

FIG. 7 illustrates a representative display stack 700 comprised of various display component layers.

FIG. 8 is a block diagram illustrating components of an example machine able to read instructions from a machine-readable medium and execute them in a processor (or controller), according to one example embodiment.

FIG. 9 illustrates a rear view of the e-paper tablet 500 showing volcano fee 901a-901d, a pogo pad 903, and an antenna region 905, according to an embodiment of the invention.

FIG. 10 illustrates a top view of the e-paper tablet device 500 showing volcano feet 901a, 901d, and a power button 1001, according to an embodiment of the invention.

FIG. 11 illustrates a bottom view of the e-paper tablet device 500 showing volcano feet 901b, 901d and the USB-c connector 507, according to an embodiment of the invention.

FIG. 12 illustrates a right view of the e-paper tablet device 500 showing volcano feet 901b, 901a, and the charging area 504 for recharging the input device 320, when the input device is an active pen-stylus, according to an embodiment of the invention.

FIG. 13 illustrates a left view of the e-paper tablet device 500 showing volcano feet 901c, 901d, according to an embodiment of the invention.

FIG. 14 illustrates an ambient light sensor 1405 in a frontlight 1400 having a lightguide 1403 positioned at the top of a structure into which the light source (e.g., LEDs 1406a-1406h) provides light when the ambient light sensor 1405 indicates a low light level condition.

FIG. 15 illustrates a frontlight 1500 having an ambient light sensor 1506 along with other components in a display stack, such as the display stack 700 shown in FIG. 7.

FIG. 16 illustrates a block diagram for an ambient light control system 1600 in a tablet device (e.g., the e-paper tablet device 310 shown in FIG. 4).

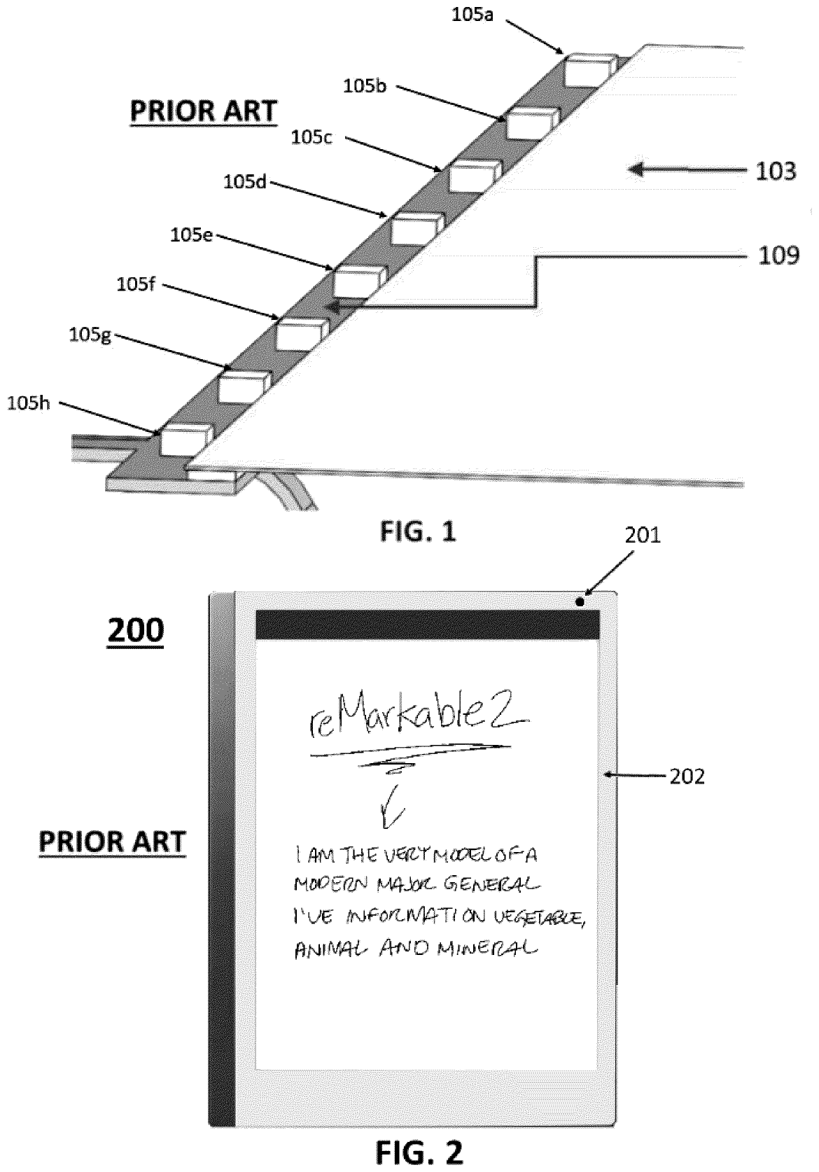

The figures depict various embodiments of the presented invention for purposes of illustration only. One skilled in the art will readily recognize from the following discussion that alternative embodiments of the structures and methods illustrated herein may be employed without departing from the principles described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. An ordinarily skilled artisan will readily recognize from the following description that alternative embodiments of the structures and methods illustrated herein may be employed without departing from the principles described herein.

### Overview

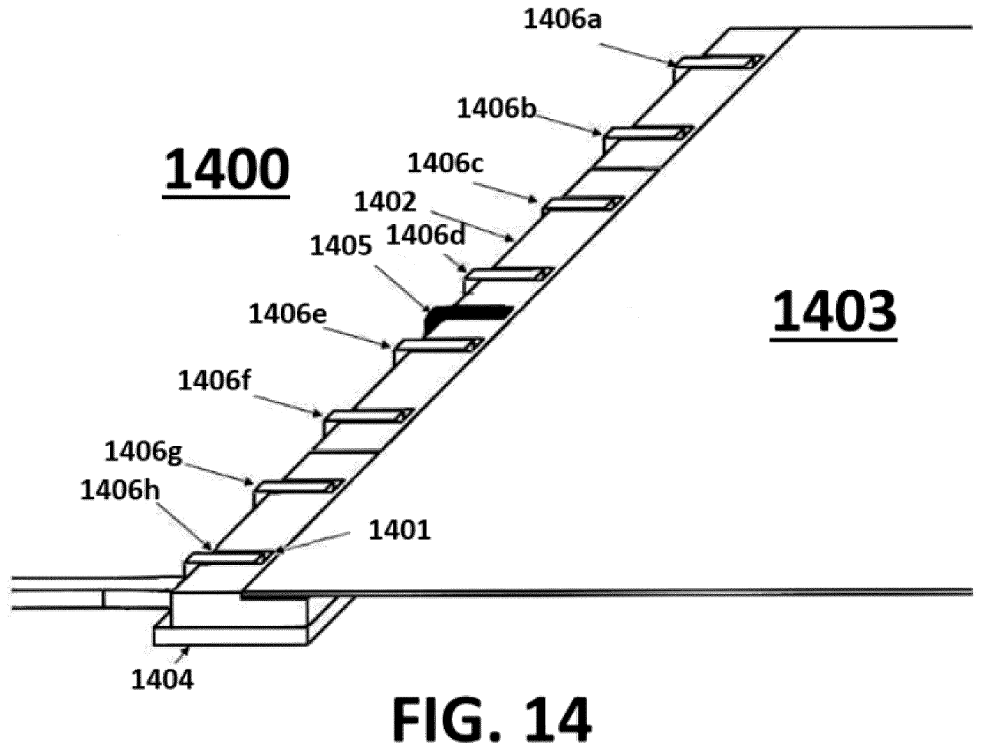

Disclosed is a system for an ambient light sensor for a frontlight that provides a solution for automatic control over the brightness of the frontlight for the user while also balancing battery lifetime. A description of a specific embodiment of the invention begins at FIG. 14. Before describing the invention in greater detail, a description will be provided of the e-paper tablet into which embodiments of the invention may be applied. As discussed, for paper tablets and other devices having a frontlight, users would like to have control of the brightness of the display while also balancing battery lifetime with the need for light based on ambient light conditions. Paper tablets may include soft switches (and/or hard switches) that allow users to actuate the frontlight themselves. However, attaining a good user experience may also call for the automatic control of the frontlight.

To control the light automatically the ambient light must be measured. Ambient light is conventionally measured using a dedicated ambient light sensor (ALS). As shown in FIG. 2, the ALS typically needs a physical opening into the device, through which light can be sensed. These light openings are typically not desired from a product design and robustness perspective, and are also vulnerable to being covered, for example, by the user's hand during operation.

An ambient light sensor is typically needed for implementing basic automated control of the light generated by a frontlight. From a battery lifetime perspective, the ability of the device to turn off the frontlight if there is enough ambient light offers a sizeable advantage. In addition, there are likely many user scenarios where the user forgets to turn off the frontlight. Thus, users will know that the device will automatically turn off its frontlight when the light is no longer needed.

To provide a context for the implementation of an improved ambient light sensor in devices having frontlights, the initial portion of the following disclosure describes a tablet device into which the frontlight and an improved ambient light sensor configuration could be applied. An ordinary artisan will recognize and appreciate that the frontlight disclosed is amenable to incorporation in a number of different devices and not just the tablet computing device described.

### Example Tablet System and Configuration

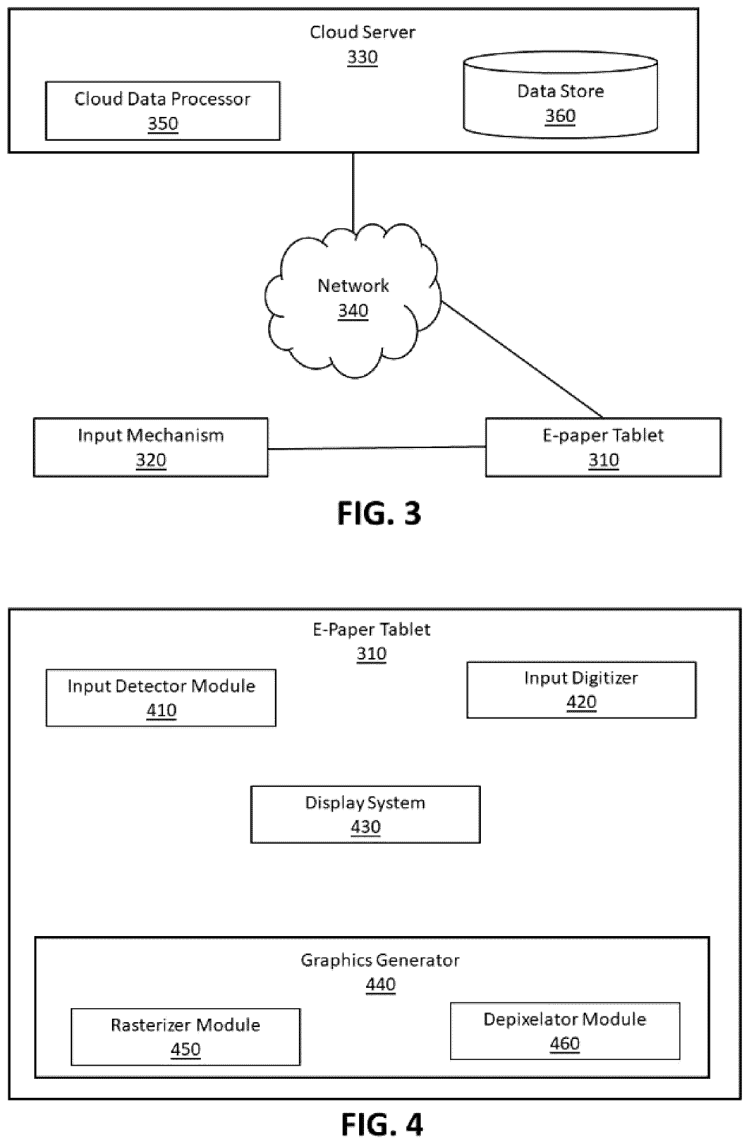

As shown in FIG. 3, an e-paper tablet device 310 receives inputs from the input mechanism 320, for example, when the input mechanism 320 makes physical contact with a contact-sensitive surface (e.g., the touch-sensitive screen) on the e-paper tablet device 310 as the user makes a gesture of some sort with the input mechanism 320. The input mechanism 320 may be a finger, pen-stylus or marker. The tablet device 310 here is referred to as an “e-paper tablet,” a device that mimics the feeling of writing with ordinary pen and paper for users of the device. Such devices are also known as “electronic paper” and “electronic ink”. Based on the nature of the contact, the e-paper tablet device 310 generates and executes instructions for updating content displayed on the contact-sensitive screen to reflect the gesture inputs. For example, in response to a gesture transcribing a verbal message (e.g., a written text or a drawing), the e-paper tablet device 310 updates the contact-sensitive screen to display the transcribed message. As another example, in response to a gesture selecting a navigation option, the e-paper tablet device 310 updates the screen to display a new page associated with the navigation option. While embodiments of the invention have been designed for e-paper systems, embodiments of the invention may also be suitable for other forms of computing devices capable of receiving and processing inputs from pen-stylus devices.

The input mechanism 320 may refer to any device or object that is compatible with the contact-sensitive screen of the e-paper tablet device 310, in particular a pen-stylus device, such as a so-called active pen device having its own power source or a static pen that receives its power from engagement with the contact-sensitive screen on the e-paper tablet device 310. In one embodiment, the input mechanism 320 may work with an electronic ink (e.g., E-ink) contact-sensitive screen. For example, the input mechanism 320 may refer to any device or object that can interface with a screen and, from which, the screen can detect a touch or contact of said input mechanism 320. Once the touch or contact is detected, electronics associated with the screen generate a signal which the e-paper tablet device 310 can process as a gesture that may be provided for display on the screen. Upon detecting a gesture by the input mechanism 320, electronics within the contact-sensitive screen generate a signal that encodes instructions for displaying content or updating content previously displayed on the screen of the e-paper tablet device 310 based on the movement of the detected gesture across the screen. For example, when processed by the e-paper tablet device 310, the encoded signal may cause a representation of the detected gesture to be displayed on the screen of the e-paper tablet device 310, such as a scribble. As mentioned, the input mechanism 320 may be a pen-stylus or another type of pointing device, including a part of a user's body, such as a finger.

In one embodiment, the input mechanism 320 is an encased magnetic coil. When in proximity to the screen of the e-paper tablet device 310, the magnetic coil helps generate a magnetic field that encodes a signal that communicates instructions, which are processed by the e-paper tablet device 310 to provide a representation of the gesture for display on the screen, e.g., as a marking. The input mechanism 320 may be pressure and tilt-sensitive such that the system can make natural, visual response to both the pressure and tilt applied by the user. In turn, the interaction between the input mechanism and the contact-sensitive screen of the e-paper tablet device 310 may generate a different encoded signal for processing, for example, to provide for display a representation of the gesture on the screen that has different characteristics, e.g., thicker line marking. In alternate embodiments, the input mechanism 320 includes a power source (e.g., a battery) which can generate an electric field with a contact-sensitive surface. It is noted that the encoded signal is a signal that is generated and may be communicated. The encoded signal may have a signal pattern that may be used for further analog or digital analysis (or interpretation).

In one embodiment, the contact-sensitive screen is a capacitive touchscreen. The screen may be designed using a glass or polymer material coated with a conductive material. Electrodes, or an alternate current carrying electric component, are arranged along the coating of the screen (e.g., in a diamond-shaped cross hatch) to maintain a constant level of current running throughout the screen. A second set of electrodes are arranged horizontally. The matrix of vertical active electrodes and horizontal inactive electrodes generates an electrostatic field at each point on the screen. When an input mechanism 320 with conductive properties, for example the encased magnetic coil, a human finger, or something else that triggers the capacitive effect, is brought into contact with an area of the screen of the e-paper tablet device 310, current flows through the horizontally arranged electrodes, disrupting the electrostatic field at the contacted point on the screen. The disruption in the electrostatic field at each point that a gesture covers may be measured, for example as a change in capacitance, and encoded into an analog or digital signal.

In an alternate embodiment, the contact-sensitive screen is a resistive touchscreen. The resistive touch screen comprises two metallic layers: a first metallic layer in which striped electrodes are positioned on a substrate, such as a glass or plastic and a second metallic layer in which transparent electrodes are positioned. When contact from an input mechanism, for example a pen-stylus, finger, or palm, is made on the surface of the touchscreen, the two layers are pressed together. Upon contact, a voltage gradient is applied to the first layer and measured as a distance by the second layer to determine a horizontal coordinate of the contact on the screen. The voltage gradient is subsequently applied to the second layer to determine a vertical coordinate of the contact on the screen. The combination of the horizontal coordinate and the vertical coordinate register an exact location of the contact on the contact-sensitive screen. Unlike capacitive touchscreens which rely on conductive input mechanisms, a resistive touchscreen is configured to sense contact from nearly any input mechanism. Although some embodiments of the e-paper tablet device 310 are described herein with reference to a capacitive touchscreen, one skilled in the art would recognize that a resistive touchscreen could also be implemented.

In an alternate embodiment, the contact-sensitive screen is an inductive touchscreen. An inductive touchscreen comprises a metal front layer that is configured to detect deflections when contact is made on the screen by an input mechanism. Accordingly, an inductive touchscreen is configured to sense contact from nearly any input mechanism. Although some embodiments of the e-paper tablet device 310 are described herein with reference to a capacitive touchscreen, an ordinarily skilled artisan would recognize that alternative touchscreen technology may be implemented, for example, an inductive touchscreen could also be implemented.

The cloud server 330 is configured to receive information from the e-paper tablet device 310 and/or communicate instructions to the e-paper tablet device 310, according to some embodiments of the invention. As illustrated in FIG. 3, the cloud server 330 may comprise a cloud data processor 350 and a data store 360. Data recorded and stored by the e-paper tablet device 310 may be communicated via the network 340 to the cloud server 330 for storage in the data store 360. For example, the data store 360 may store documents, images, or other types of content generated or recorded by a user through the e-paper tablet device 310. In some embodiments, the cloud data processor 350 monitors the activity and usage of the e-paper tablet device 310 and communicates processing instructions to the e-paper tablet device 310. For example, the cloud data processor 350 may regulate synchronization protocols for data stored in the data store 360 with the e-paper tablet device 310.

Interactions between the e-paper tablet device 310 and the cloud server 330 are typically performed via the network 340, which enables communication between the e-paper tablet device 310 and the cloud server 330. In one embodiment, the network 340 uses standard communication technologies and/or protocols including, but not limited to, links using technologies such as Ethernet, 802.11, worldwide interoperability for microwave access (WiMAX), 3G, 4G, LTE, digital subscriber line (DSL), asynchronous transfer mode (ATM), InfiniBand, and PCI Express Advanced Switching. The network 340 may also utilize dedicated, custom, or private communication links. The network 340 may comprise any combination of local area and/or wide area networks, using both wired and wireless communication systems. The cloud server 330 may be alternatively implemented, and in some embodiments may be replaced by hardware and software that provide similar functionality while possibly not being considered a conventional cloud server.

FIG. 4 is a block diagram of the system architecture of an e-paper tablet device 310, according to one example embodiment. In the embodiment illustrated in FIG. 4, the e-paper tablet device 310 comprises an input detector module 410, an input digitizer 420, a display system 430, and a graphics generator 440.

The input detector module 410 recognizes that a gesture has been or is being made on the screen of the e-paper tablet device 310. The input detector module 410 refers to electronics integrated into the screen of the e-paper tablet device 310 that are configured to interpret an encoded signal generated by contact between the input mechanism 320 and the screen into a recognizable gesture. To do so, the input detector module 410 may evaluate properties of the encoded signal to determine whether the signal represents a gesture made intentionally by a user or a gesture made unintentionally by a user.

The input digitizer 420 may be configured to convert the analog signal encoded by the contact between the input mechanism 320 and the screen into a digital set of instructions. The converted digital set of instructions may be processed by the e-paper tablet device 310 to generate or update a user interface displayed on the screen to reflect an intentional gesture.

The display system 430 may include the physical and firmware (or software) components to provide for display (e.g., render) on a screen a user interface. The user interface may correspond to any type of visual representation that may be presented to or viewed by a user of the e-paper tablet device 310.

Based on the digital signal generated by the input digitizer 420, the graphics generator 440 may be configured to generate or update graphics of a user interface to be displayed on the screen of the e-paper tablet device 310. The display system 430 may be configured to present those graphics of the user interface for display to a user using electronics integrated into the screen.

When an input mechanism 320 makes contact with a contact-sensitive screen of an e-paper tablet device 310, the input detector module 410 recognizes a gesture has been made through the screen. The gesture may be recognized as a part of an encoded signal generated by a pressure or force sensor in the input mechanism 320 and/or corresponding electronics of the screen of the display system 430. The encoded signal is transmitted to the input detector module 410, which evaluates properties of the encoded signal in view of at least one gesture rule to determine whether the gesture was made intentionally by a user. If the input detector module 410 determines that the gesture was made intentionally, the input detector module 410 communicates the encoded signal to the digitizer output. The encoded signal is an analog representation of the gesture received by a matrix of sensors embedded in the screen of the device 310.

In one example embodiment, the input digitizer 420 translates the physical points on the screen that the input mechanism 320 made contact with into a set of instructions for updating what is provided for display on the screen. For example, if the input detector module 410 detects an intentional gesture that swipes from a first page to a second page, the input digitizer 420 receives the analog signal generated by the input mechanism 320 as it performs the swiping gesture. The input digitizer 420 generates a digital signal for the swiping gesture that provides instructions for the display system 430 of the e-paper tablet device 310 to update the user interface of the screen to transition from, for example, a current (or first page) to a next (or second page, which may be before or after the first page).

In one example embodiment, the graphics generator 440 receives the digital instructional signal, such as a swipe gesture indicating page transition (e.g., flipping or turning) generated by the input digitizer 420. The graphics generator 440 generates graphics or an update to the previously displayed user interface graphics based on the received signal. The generated or updated graphics of the user interface are provided for display on the screen of the e-paper tablet device 310 by the display system 430, e.g., displaying a transition from a current page to a next page to a user. In the displayed embodiment of the FIG. 4, the graphics generator 440 comprises a rasterizer module 450 and a depixelator module 460. Input gestures drawn by a user on a contact-sensitive surface are received as vector graphics and are input to the rasterizer module 450. The rasterizer module 450 converts the input vector graphics to raster graphics, which can be displayed (or provided for display) on the contact-sensitive surface. The depixelator module 460 may apply image processing techniques to convert the displayed raster graphics back into vector graphics, for example to improve processing power of the e-paper tablet device 310 and to conserve memory of the e-paper tablet device 310. In at least one implementation, the depixelator module 460 may convert a displayed raster graphic back to a vector graphic when exporting content displayed on the screen into a different format or to a different system.

Further details about structures and functions of e-paper tablets and their graphical displays can be found in U.S. Pat. No. 11,158,097 to Martin Sandsmark and Gunnar Sletta entitled “Generating vector graphics by processing raster graphics” and in U.S. Pat. No. 10,824,274 to Sondre Hoff Dyvik, Martin Sandsmark, and Magnus Haug Wanberg, entitled “Interactive displays,” both of which are incorporated by reference herein.

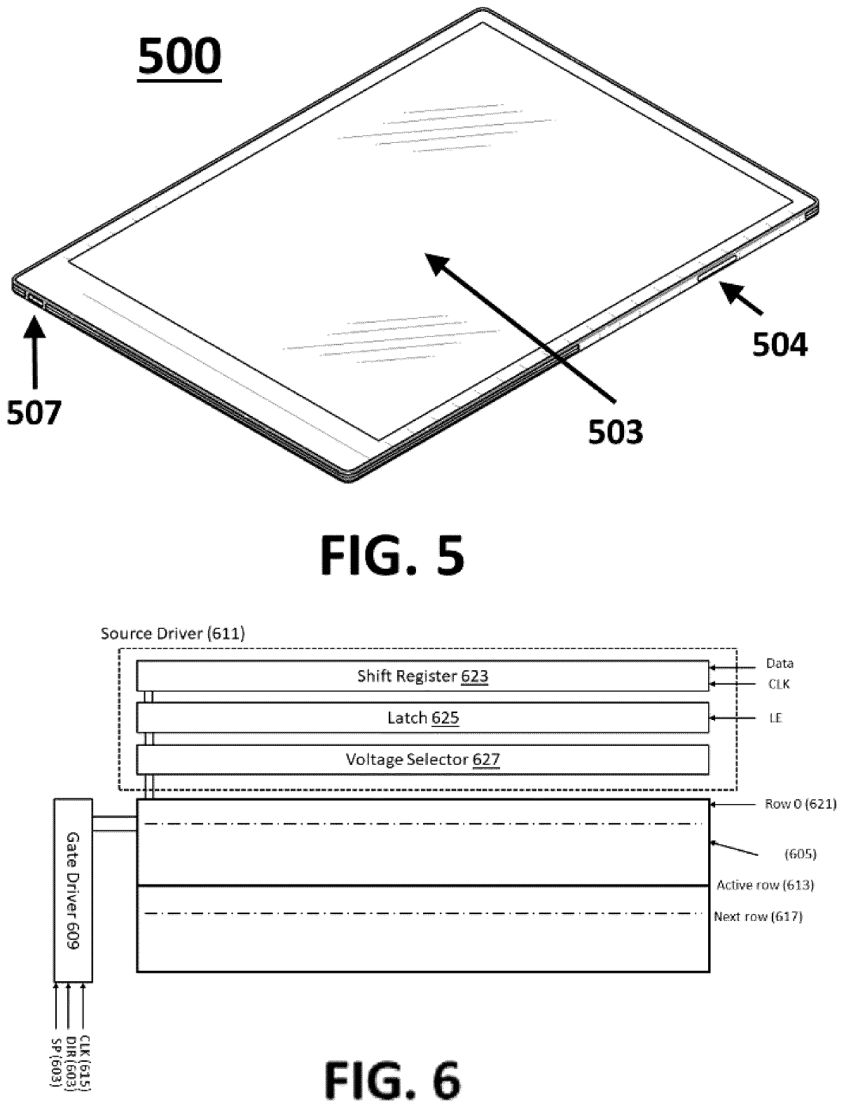

FIG. 5 illustrates a front and right perspective view of an e-paper tablet 500 having the functionality described for the e-paper tablet device 310 in FIGS. 3-4. Among other things, the e-paper table 500 includes a touch-sensitive display 503. The display 503 has been treated to provide a paper-feeling for users of the device when they engage with it using an input device 320. FIG. 5 also shows a charging area 504 for recharging the input device 320, when the input device is an active pen-stylus, according to an embodiment of the invention. Inside the e-paper tablet 500 near where the charging area 504 is located may be a set of magnets to hold the input device 320 in place while it is re-charging. FIG. 5 also shows a USB-c connector 507 that may be used to provide electrical power to the e-paper tablet 500, as well as transmitting various types of data into or out of the e-paper tablet 500. The e-paper tablet 500 also includes several actuators and other features that will be shown below in FIGS. 5-13.

FIG. 6 illustrates hardware components of an example Electrophoretic Display (EPD) in accordance with a disclosed embodiment. As discussed, a variety of display technologies may be employed, including EPDs, LCDs, and reflective LCDs (rLCDs). The specific display device deployed may be part of the display system 430 of the e-paper tablet device 310 shown in FIG. 4 and produce the images shown on the display 503 of the e-paper tablet 500 shown in FIG. 5. The EPD includes a gate driver 609, a source driver 611, a shift register 623 with data and clock signal line, a latch 625, a voltage selector 627, and rows making up a display 605. The EPD industry borrowed certain components and concepts from the LCD industry; however, these two devices have some fundamental differences as well. Of particular relevance here is the persistence of pixels in EPD displays. Unlike LCD displays, EPD displays do not require the frequent refreshing required in an LCD display. In an EPD display, once a neutral voltage is set for a pixel, the pixel will not change, for example, and will persist for a long period of time, especially relative to an LCD display.

As mentioned, Electrophoretic displays (EPDs) 605 have utilized many aspects of LCD production infrastructure and driving mechanisms. The driving electronics typically consist of a gate driver (GD) 609 and a source driver (SD) 611. The display 605 has multiple rows of pixels. Pixel values within a row may be changed, e.g., logic high voltage may be a “black” pixel and a logic low voltage or “ground” may be a no color pixel. The pixels in the EPD 605 function similarly to small capacitors that persist over long time intervals. An EPD pixel contains a large number of charged particles that are suspended in a liquid. If a charge is applied, the particles will move to a surface where they become visible. White and black particles have opposite charges such that a pixel's display may change from white to black by applying an opposite charge to the pixel. Thus, the waveforms applied to an EPD comprise long trains of voltages to change from black to white or vice versa. The EPD arts are also known to have the ability to apply variable voltage levels that mix the white and black particles to produce various shades of gray. Voltage levels in a pixel also may be tiered between to provide shades between no color and black (e.g., levels of grey). Groups of pixels around each other may form a region that provides some visible characteristic to a user, e.g., an image on a screen, e.g., of the display system 430 of the e-paper tablet device 310.

To change pixel values in a region, a scan of a display 605 will conventionally start at a top row, e.g., row 0 421, and apply voltages to update pixels within a particular row where pixels need to be changed to correspond with the image that is displayed. In this example, a start pulse (GDSP) 603 can be used to reset the driver 611 to row 0 621. A row-by-row selection is made by driving the driver gate 609 to select a row, e.g., active row 613. All pixels in one row are addressed concurrently using data transferred to the display. Latch 625 receives from the shift register 623 the next set of voltages to be applied to a row of pixels. When the scan of the active row is completed and, if necessary, pixels changed or updated, a clock pulse (GDCLK) 315 is issued to the driver gate 609 to change to the next row 617 for a scan.

As mentioned above, an ordinary artisan will recognize that a similar function can be accomplished also with a standard LCD, OLED, MicroLED or other type of display, and the description of EPD technology is provided here merely for illustration of one embodiment of the invention.

The source driver 611 is used to set the target voltage for each of the pixels/columns for the selected row. It consists of a shift register 623 for holding the voltage data, a latch circuit 625 for enabling pixel data transfer while the previous row is being exposed, and a voltage selector (multiplexer) 627 for converting the latched voltage selection into an actual voltage. For all rows to be updated all the voltage values have to be shifted into the register 623 and latched for the voltages to be available.

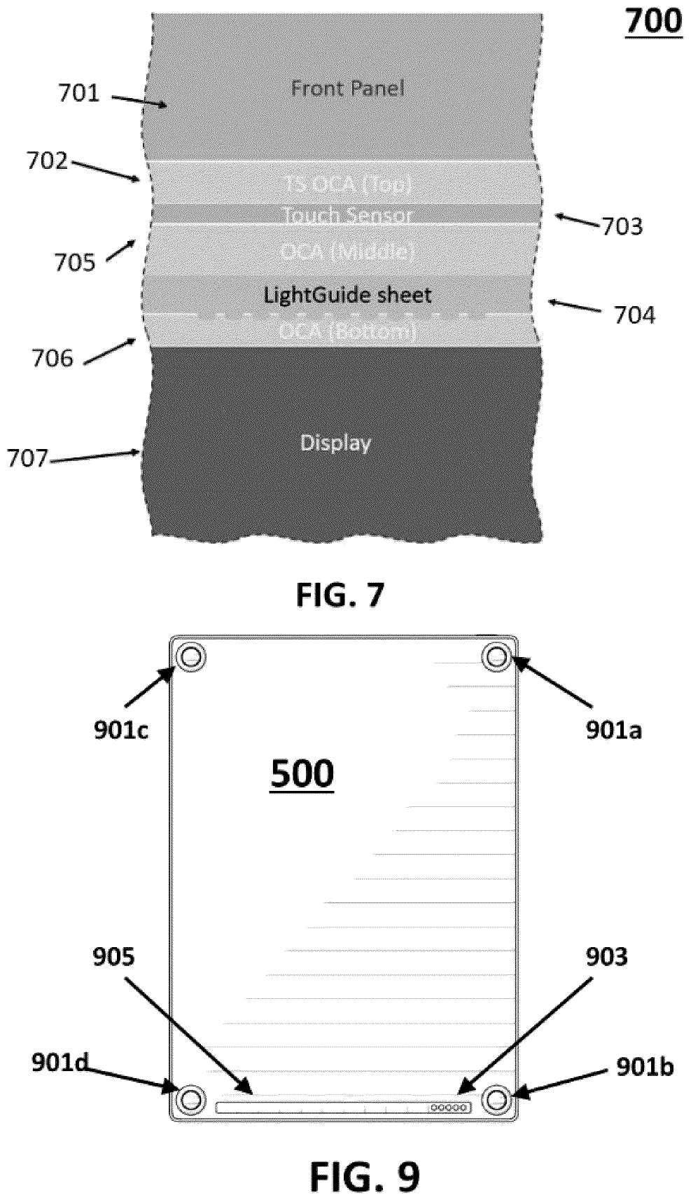

FIG. 7 illustrates a representative display stack 700 comprised of various display component layers. From the bottom layer to a top layer, these layers comprise an EPD display 707, an optical clear adhesive layer 706, a lightguide sheet 704, an optical clear adhesive layer 705, a touch sensor 703, an optical clear adhesive layer 702, and a front panel 701. The EPD display 707 may comprise components similar to those described in FIG. 4. If writing technology is present (not shown in FIG. 7, but if present, then it is likely below the EPD display 707), the writing technology may comprise similar elements to the graphics generator 340 disclosed in FIG. 4. The optical clear adhesive layers 706, 704, 702 are employed to attach components from other portions in the stack 700 together but to do so in a manner that does not alter or impede the light transiting through the stack 700 to the user. The touch sensor 703 operates as a portion of the touchscreen that has been described above. The stack 700 is conventionally capped by a front panel 701 that the user may touch during device operation. The front panel 701 is conventionally comprised of glass but could be comprised of other materials. For example, U.S. Provisional Application No. 63/314,500, filed on 28 Feb. 2022, entitled “Cover Lens for Consumer Electronics Device,” incorporated by reference, describes one such front panel suitable for implementation in the stack 700.

The lightguide sheet 704 could comprise several different types of lightguides, including ultra-thin lightguide sheet (e.g., 50 um). However, conventional lightguides could just as easily be employed. As discussed above, consumer demands have compelled display stacks like the display stack 700 to become increasingly thinner so that the overall device (e.g., the e-paper tablet device 410) can itself become thinner and so that the parallax effect due to the separation between the EPD and the writing surface can be reduced.

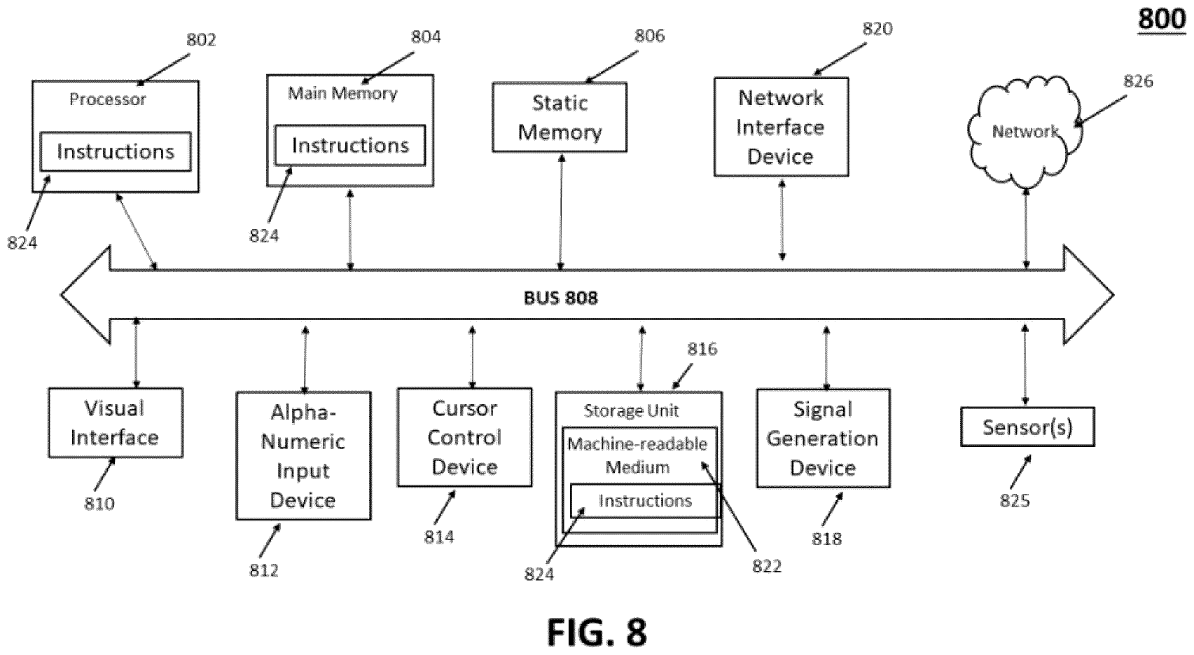

FIG. 8 is a block diagram illustrating components of an example machine able to read instructions from a machine-readable medium and execute them in a processor (or controller), according to one embodiment. In this example, FIG. 8 shows a diagrammatic representation of a machine in the example form of a computer system 800 (e.g., the computing portions of the e-paper tablet 311 shown in FIG. 3) within which program code (e.g., software) for causing the machine to perform any one or more of the methodologies discussed herein may be executed. The e-paper tablet device 310 may include some or all of the components of the computer system 800. The program code may be comprised of instructions 824 executable by one or more processors 802. In the e-paper tablet system 310, the instructions may correspond to the functional components described in FIGS. 3, 4, and 6, for example. FIG. 8 is an example of a processing system, of which a some of the described components or all of the described components may be leveraged by the modules described herein for execution.

While the embodiments described herein are in the context of the e-paper tablet system 310, it is noted that the principles may apply to other touch sensitive devices. In those contexts, the machine of FIG. 8 may be a server computer, a client computer, a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors 802 (e.g., a central processing unit (CPU), one or more graphics processing units (GPU), one or more digital signal processors (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include visual display interface 810. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen or display screen. The visual interface 810 may include or may interface with a touch enabled screen, e.g., of the e-paper tablet system 310 and may be associated with the display system 430. The computer system 800 may also include an input device 812 (e.g., a pen-stylus, a keyboard, or touch screen keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored (or encoded) instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

The computer system 800 also may include the one or more sensors 825. Also note that a computing device may include only a subset of the components illustrated and described with FIG. 8. For example, an IoT device may only include a processor 802, a small storage unit 816, a main memory 804, a visual interface 810, a network interface device 820, and a sensor 825.

### Representative E-Paper Tablet

FIG. 5 provided a representative view of an e-paper tablet 500, resembling the e-paper 310 shown in FIGS. 3-4. FIG. 9 illustrates a rear view of the e-paper tablet 500 showing volcano fee 901a-901d, a pogo pad 903, and an antenna region 905, according to an embodiment of the invention. The antenna region 905 resides outside and above the location for a main antenna for the e-paper tablet 500, allowing the e-paper tablet device 500 to connect to the Internet, for example. The pogo pad 903 allows the e-paper tablet device 500 to connect to other devices, such as a folio device having a keyboard, for example.

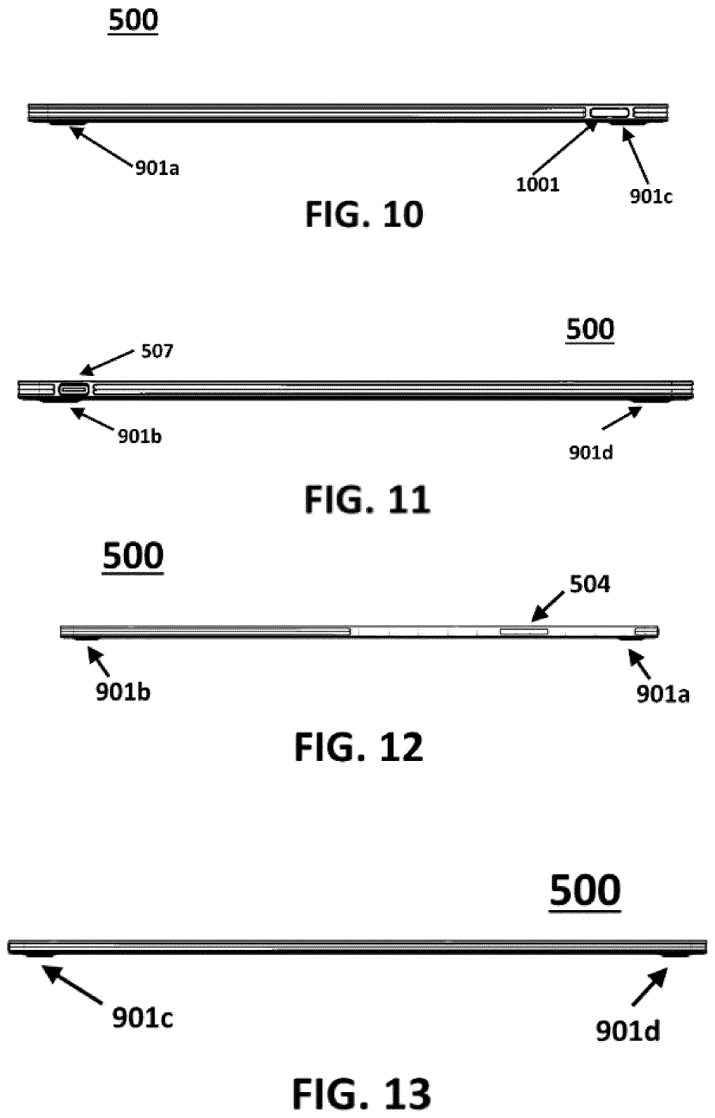

FIG. 10 illustrates a top view of the e-paper tablet device 500 showing volcano feet 901a, 901d, and a power button 1001, according to an embodiment of the invention.

FIG. 11 illustrates a bottom view of the e-paper tablet device 500 showing volcano feet 901b, 901d and the USB-c connector 507, according to an embodiment of the invention.

FIG. 12 illustrates a right view of the e-paper tablet device 500 showing volcano feet 901b, 901a, and the charging area 504 for recharging the input device 320, when the input device is an active pen-stylus, according to an embodiment of the invention. Inside the e-paper tablet 500 near where the charging area 504 is located may be a set of magnets to hold the input device 320 in place while it is re-charging.

FIG. 13 illustrates a left view of the e-paper tablet device 500 showing volcano feet 901c, 901d, according to an embodiment of the invention.

### Example of a Frontlight Having an Ambient Light Sensor

FIGS. 14-16 describe embodiments of a frontlight having an ambient light sensor that aids in efficiently turning on and off the light being emitted by the frontlight in response to changing ambient lighting conditions. Embodiments of the invention offer a solution to the problem of automatically turning on and off a frontlight in response to changes in ambient light conditions without having to change or disfigure an outer surface of the device (e.g., the e-paper tablet device 210 shown in FIG. 2), which would be the case with a conventional ambient light sensor (e.g., the ambient light sensor 201 located on the surface of the interactive display device 200 shown in FIG. 2.)

Embodiments of the invention attempt to solve to the problem of ambient light detection in devices using EPD displays by incorporating the ambient light sensor onto the same light distribution layer as the LEDs that provide light into the lightguide for the frontlight. The resulting frontlight with ambient light sensor is suitable for implementation in a display stack, such as the display stack 700 shown in FIG. 7 and ultimately suitable for integration into devices, such as the e-paper tablet device 410 shown in FIG. 4.

FIG. 14 illustrates an ambient light sensor 1405 in a frontlight 1400 having a lightguide 1403 positioned in a structure into which the light source (e.g., LEDs 1406a-1406h) provides light when the ambient light sensor 1405 indicates a low light level condition (e.g., a predetermined level that may correspond to a light level at which a typical user has difficulty reading the tablet's display). This structure, optical coupling element 1402, is placed adjacent to the lightguide 1403. The light sources may be placed adjacent to the optical coupling element 1402, or in a recess 1401 in the optical coupling element as shown on FIG. 14. Thus, the optical coupling element 1402 resides between the lightguide 1403 and the light source (e.g., LEDs 1406a-1406h).

Because the lightguide 1403 acts as a light distribution layer, the lightguide 1403 may function as a two-way component. While the lightguide 1403 spreads light from the LEDs 1406a-1406h across the display, the lightguide 1403 may also collect ambient light and direct it towards the edge where the ambient light sensor 1405 and LEDs 1406a-1406h are placed.

Thus, the ambient light sensor 1405 may be placed in a similar location to the location of the LEDs 1406a-1406h. The ambient light sensor 1405 detects the ambient light collected by the lightguide 1403, effectively serving as a light level sensor that is useful for turning on/off the frontlight and/or adjusting the light levels provided by the frontlight. For example, the frontlight 1400 may switch on when an ambient light level drops below a level at which users have difficulty reading the tablet's display and may switch off when an ambient light level exceeds a level at which users may read the tablet's display without the need for the frontlight 1400.

The lightguide 1403 presents a large light collection surface. Because this surface is large, the prior art issue involving the sensor input hole being covered by a hand or by dirt is largely (if not entirely) eliminated. In addition, the frontlight's LED strip where the ambient light sensor 1405 is located is covered by a front panel (such as the front panel 701 shown in FIG. 7) and not visible to the end user. Thus, the impact of requiring a separate opening for a light sensor in the device design is also mitigated. Put another way, the tablet's design and aesthetics are not disrupted by an opening hole for the light sensor.

As shown in FIG. 14, the ambient light sensor 1405 shares the lightguide 1403 with the front light LEDs (1406a-1406h). The actual ambient light must be calculated as a function of the known emitted light and the ambient light, as discussed in connection with the ambient light control system 1600 disclosed in FIG. 16. The relevant calculation can be computed in the microcontroller in the system (e.g., the processor 1605 shown in FIG. 16). The algorithm implemented in the microcontroller is a fairly conventional algorithm that should be known to ordinarily skilled artisans in the relevant field.

In terms of its construction, the ambient light sensor 1405 may comprise a dedicated light sensor component. As an alternative, a conventional LED may be employed as the ambient light sensor because a conventional LED generates current relative to the incoming ambient light. So, for example, the ambient light sensor 1405 may be an LED. Detecting light with an LED is a skill known by ordinarily artisans and can be performed in different ways. Ordinary artisans may want to determine for a given implementation where they obtain a desired balance between speed of detection and accuracy. The LED acting as the ambient light sensor 1405 would generate a small current from ambient light received from the lightguide 1403 and at certain levels of detected ambient light can be used to turn on or turn off the frontlight (e.g., the LEDs 1406a-1406h). The ambient light sensor 1405 (whether an LED or another sensor type) could also be configured to adjust the light from the frontlight to provide more light settings than just on/off but could provide a number of ranges that would accordingly impact the light level coming from the frontlight. More than one ambient light sensor 1405 may be employed in some embodiments of the invention.

Using an LED as the ambient light sensor 1405 may present variations in accuracy. The tablet device (e.g., the e-paper tablet device 310 shown in FIG. 4) may have a moveable cover (e.g., a folio) over its display when not in use. If the tablet device has a mechanism to detect that the cover is closed (e.g., a magnet and Hall Effect sensor), a control system for the ambient light sensor can perform a calibration of the ambient light sensor LEDs when the cover is known to be closed. Among other things, this would provide an indication regarding how much light was still being received when the device cover was closed and the user was presumably not using the device (e.g., a condition where the frontlight should presumably be turned off so as to save battery power.)

The recess (e.g., the recess 1401) for the LEDs 1406a-1406h and the ambient light sensor 1405 may include small gaps at either side. These gaps are not necessary for the optical functioning of the frontlight 1400 but may be included to allow for manufacturing tolerances. The optical coupling element 1402 typically has a height that is greater than or equal to the height of the light source (e.g., LEDs 1406a-1406h).

The optical coupling element 1402 is typically comprised of the same material (e.g., a polycarbonate) as the lightguide 1403. The optical coupling element 1402 has the same refractive index as the lightguide 1403. The optical coupling element 1402 does not have to be perfectly index matched to the lightguide 1403; preferably, the optical coupling element 1402 is index matched to the lightguide 1403, otherwise the efficiency is likely reduced. In the frontlight 1400, the light source (e.g., LEDs 1406a-1406h) rests on a circuit board 1404 (e.g., a flex PCB) which also supports the optical coupling element 1402. The lightguide 1403 is supported by other layers of the display stack above or below it which are not shown in FIG. 14.

In some embodiments of the invention, a wire coming from the ambient light sensor 1405 may be bundled (e.g., in a flex cable) with the wires attached to LEDs 1406a-1406h. However, as previously noted, the wires attached to the LEDs 1406a-1406h ultimately attach to a battery that provides power for lighting the LEDs 1406a-1406h when the frontlight is engaged. In contrast, the wire coming from the ambient light sensor 1405 passes an electrical signal corresponding to detected ambient light from the lightguide 1403 into the device for further processing, such as described in connection with the ambient light control system 1600 disclosed in FIG. 16.

The optical coupling element 1402 that houses the ambient light sensor 1405 may have a number of overall shapes. FIG. 14 illustrates an essentially rectangular optical coupling element 1402, but the shape of the optical coupling element 1402 could take other forms. The rectangular shape shown in FIG. 14 is possibly easier to manufacture by some processes (e.g., molding) than if the optical coupling element 1402 had another shape. Thus, if a different manufacturing process was more optimal for some particular material, then it may be possible to adjust the shape of the optical coupling element 1402 without a significant degradation of performance.

The performance of the frontlight 1400 may depend on the specific materials selected for the lightguide 1403 and the optical coupling element 1402. For the lightguide, materials having a higher refractive index have a larger acceptance angle and so will be able to couple more light through the structure of the frontlight 1400. So, for example, polycarbonate lightguides have a larger acceptance angle than those made of Polymethyl methacrylate (PMMA). The optical absorption properties are also important—for example, Polyethylene terephthalate (PET) may be employed but is more highly absorbing of blue light and can cause a yellowing color shift which may be undesirable for some applications, such as when a “cooler” color tone is desired. The materials employed for the optical coupling element 1402 are essentially materials conventionally employed in lightguides, and a unique material does not appear to be necessary for the optical coupling element 1402.

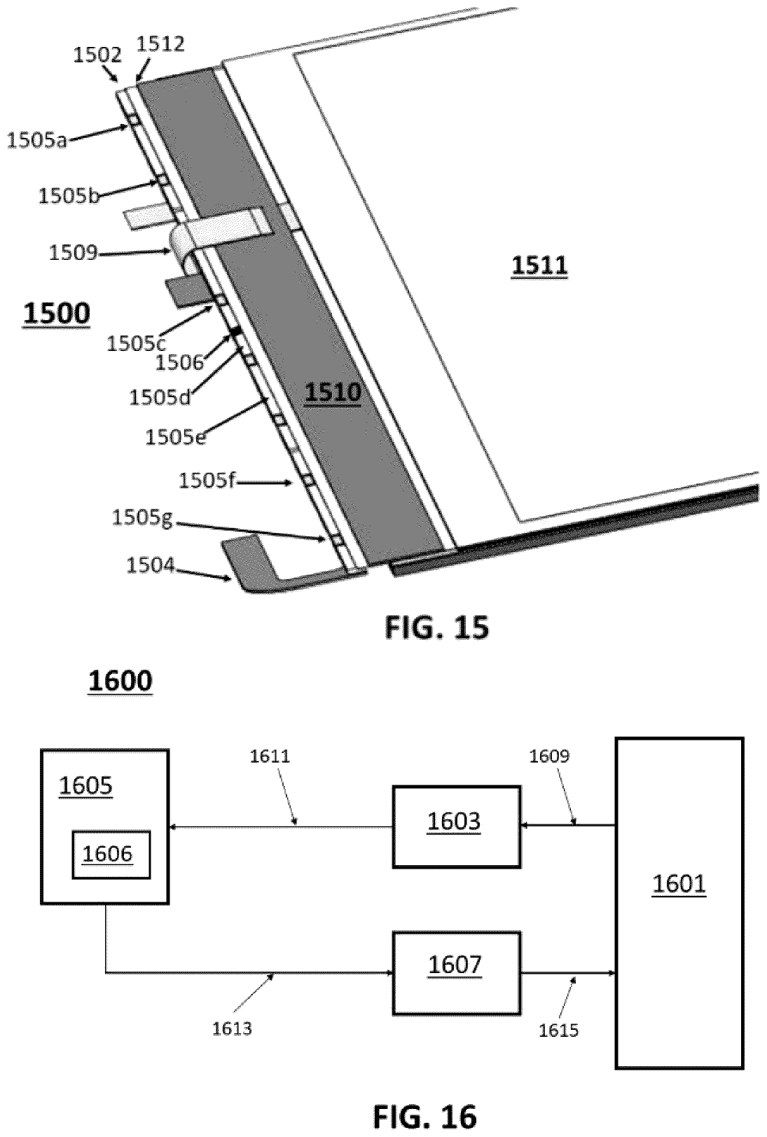

FIG. 15 illustrates an ambient light sensor 1506 in a frontlight 1500 along with other components in a display stack, such as the display stack 700 shown in FIG. 7. The frontlight 1500 comprises a lightguide 1512, an optical coupling element 1502 and a plurality of light sources (LEDs 1505a-1505g) disposed on a circuit board 1504. FIG. 15 also illustrates other components in a display stack, such as a front panel 1511 and a light blocking film 1510 which is attached to a portion of the lightguide 1512. The display stack may include a touchscreen cable 1509. FIG. 15 otherwise resembles the embodiment of the invention shown in FIG. 14.

FIG. 16 illustrates a block diagram for an ambient light control system 1600 in a tablet device (e.g., the e-paper tablet device 310 shown in FIG. 4). The ambient light control system 1600 comprises a lightguide 1601, an ambient light sensor 1603, a processor 1605, and a frontlight 1607. The lightguide 1601 provides ambient light 1609 to the ambient light sensor 1603. As discussed above, the ambient light sensor 1603 may comprise an LED. The ambient light sensor 1603 turns received ambient light from the lightguide 1601 into an electric signal 1611 that is provided to a processor 1605 (e.g., the computer system 800 shown in FIG. 8) that performs signal processing on the signal 1611 received from the ambient light sensor 1603. The signal processing may, for example, convert an analog signal to a digital signal and then perform a comparison between the detected ambient light level and certain device conditions (e.g., an ambient light level low enough for the processor 1605 to engage a command for turning on the frontlight 1607, or an ambient light level high enough for the processor 1605 to engage a command for turning off the frontlight 1607, or an ambient light condition that causes the processor 1605 to engage a command for an intermediate adjustment of the light coming from the frontlight 1607).

The processor 1605 may include a memory 1606 that includes a soft signal processor that may be engaged to perform the signal processing. The memory 1606 may also include predetermined light levels for engaging (e.g., switching on) and/or disengaging (e.g., switching off) the frontlight 1607 based on ambient light conditions, e.g., the display becomes difficult to read due to a low detected light level or the display becomes easy to read due to a high detected light level. A dedicated signal processor may be employed in some embodiments of the invention.

When the processor 1605 detects that an ambient light condition has changed, then the processor sends a signal 1613 to the frontlight 1607 instructing the frontlight 1607 to change its level of output light 1615 into the lightguide 1601.

Also, as mentioned above, if the device (e.g., the e-paper tablet device 310 shown in FIG. 4) has detected that a folio cover has been closed and provided an input (not shown) to the processor 1605, then the signal 1611 from the ambient light sensor 1603 may be used in a test function to calibrate the level of ambient light received when the device display has been covered. This information may be helpful in adjusting the predetermined lighting thresholds stored in the memory 1606.

### Additional Considerations

This disclosed configuration provides additional precision and options for users as they go about erasing portions of drawings on an e-paper tablet. This should improve the efficiency of users interacting with e-paper tablets while also enabling them with more precise functional capabilities.

It is to be understood that the figures and descriptions of the present disclosure have been simplified to illustrate elements that are relevant for a clear understanding of the present disclosure, while eliminating, for the purpose of clarity, many other elements found in a typical system. Those of ordinary skill in the art may recognize that other elements and/or steps are desirable and/or required in implementing the present disclosure. However, because such elements and steps are well known in the art, and because they do not facilitate a better understanding of the present disclosure, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

While particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

1. An ambient light sensor system, comprising:
a lightguide;
an ambient light sensor that receives ambient light from the lightguide;
a processor the receives an ambient light signal from the ambient light sensor; and
a frontlight controlled by the processor.

2. The ambient light sensor system of claim 1 wherein the processor determines that the ambient light signal has dropped below a first predetermined threshold and wherein the processor sends a signal to the frontlight that causes the frontlight to turn on.

3. The ambient light sensor system of claim 2 wherein the first predetermined threshold comprises a display light level below a user's ability to read a display on a tablet device that includes the frontlight.

4. The ambient light sensor system of claim 1 wherein the processor determines that the ambient light signal has risen above a second predetermined threshold and wherein the processor sends a signal to the frontlight that causes the frontlight to turn off.

5. The ambient light sensor system of claim 4 wherein the second predetermined threshold comprises a display light level above a user's ability to read a display on a tablet device that includes the frontlight.

6. The ambient light sensor system of claim 1 wherein the ambient light sensor comprises an LED.

7. The ambient light sensor system of claim 6 wherein the frontlight comprises a plurality of LEDs located in a common layer, and wherein the ambient light sensor resides in the common layer.

8. The ambient light sensor system of claim 7, wherein the common layer comprises an optical coupling element that resides between the lightguide and the LEDs and has a matching refractive index to the lightguide.

9. The ambient light sensor system of claim 8 wherein the optical coupling element has a height at least equal to a height of the plurality of LEDs.

10. The ambient light sensor system of claim 9 wherein the optical coupling element and the plurality of LEDs reside on a circuit board.

11. The ambient light sensor system of claim 8, wherein the optical coupling element comprises a same material as the lightguide.

12. The ambient light sensor system of claim 11 wherein the same material is a polycarbonate.

13. The ambient light sensor system of claim 1, further comprising:
a moveable cover that blocks the lightguide when moved to a closed position,
wherein the processor determines a closed position light level using an ambient light signal received from the ambient light sensor when the moveable cover is in the closed position, and
wherein the processor updates a first predetermined threshold corresponding to a low ambient light level using the closed position light level.

14. The ambient light sensor system of claim 1 wherein the lightguide resides in a display stack of a display system in a tablet device, wherein elements of the display stack support the lightguide.

15. The ambient light sensor system of claim 14 wherein the display stack includes an electrophoretic display (EPD).

16. The ambient light sensor system of claim 1, further comprising a plurality of ambient light sensors that receive ambient light from the lightguide, wherein the processor receives ambient light signals from the plurality of ambient light sensors.
